(19) United States
(12) Patent Application Publication
(10) Pub. No.: US 2015/0029096 A1
(43) Pub. Date: Jan. 29, 2015

(54) IMAGE DISPLAY DEVICE

(71) Applicant: SHARP KABUSHIKI KAISHA, Osaka-shi, Osaka (JP)

(72) Inventor: Takehisa Ishihara, Osaka-shi (JP)

(21) Appl. No.: 14/374,134

(22) PCT Filed: Dec. 6, 2012
(86) PCT No.: PCT/JP2012/081690

§ 371 Date: Jul. 23, 2014

(30) Foreign Application Priority Data
Feb. 7, 2012 (JP) 2012-024249

(51) Int. Cl. G06F 1/32; G06F 3/01

(52) U.S. Cl. CPC G06F 1/3231; G06F 3/013; G06F 1/3265
USPC 345/156

(57) ABSTRACT

There is provided an image display device which is kept from wastefully consuming electric power while an eyelid is closed by blinks in a waking state. A signal from an FIR sensor (14) is inputted to a positive (+) terminal of a comparator (32) via an amplifier (31) while a threshold (Th) is inputted to a negative (−) terminal of the comparator (32). When an eyelid (1) is closed more than necessary to block all the field of view, a level of the signal inputted from the FIR sensor (14) to the positive (+) terminal of the comparator (32) is higher than the level of the threshold (Th). Thus, a high-level signal is outputted from the comparator (32) and a low-level signal is inputted to a driver (34) via an inverter (33), so that the driver (34) turns off a backlight (12).

### TECHNICAL FIELD

The present invention relates to image display devices for displaying images in a user's field of view, such as head mounted display devices to be mounted on the head of the user or spectacle type display devices.

### BACKGROUND ART

For head mounted display devices or spectacle type display devices, it is indispensable to realize electric power saving for increasing the battery drive time. Still more, because the desire that head mounted display devices and spectacle type display devices be provided in even smaller size and lower weight inevitably entails size reduction of their batteries, there has been growing an urgent demand for electric power saving to increase the battery drive time.

A conventional head mounted display device is known from JP 2009-81529 A (PTL1). In this head mounted display device, illumination light is applied from a light emitting part to an observer's eyes, and the illumination light reflected by the eye is received by a light receiving part. When the illumination light received by the light receiving part is higher than a predetermined threshold value, it is decided as an eyelid closed state. In this way, an opening/closing action of the eyelid is detected. Then, the opening/closing number of the eyelid per unit time is counted. If the opening/closing number of the eyelid per unit time exceeds a predetermined reference value, it is decided as a state immediately before entry into a sleeping state, where the image display is stopped so that an electric power saving is achieved.

### CITATION LIST

### Patent Literature

PTL1: JP 2009-81529 A

### SUMMARY OF INVENTION

### Technical Problem

The observer, who is a user of the image display device, repeatedly blinks at all times even in his/her waking state other than the state immediately before entry into a sleeping state.

Unfortunately, in conventional head mounted display devices, although the image display is stopped in a sleeping state so that an electric power saving can be achieved to some extent, yet the image display is exerted even when the eyelid is closed by a blink in a waking state. Thus, there is a problem that electric power is consumed wastefully.

Accordingly, an object of the present invention is to provide an image display device which is kept from wastefully consuming electric power while the eyelid is closed by a blink in the waking state.

### Solution to Problem

In order to solve the problem, an image display device according to the present invention comprises:

an image display section;

a sensor for detecting opening/closing operation of an eyelid of an observer who observes the image display section; and

a control unit for, upon receiving a signal from the sensor, exerting control to turn off the image display section on condition that the observer's eyelid is kept closed to an extent equal to or more than a predetermined certain value.

According to the image display device of the above structure, the control unit, upon receiving a signal from the sensor that detects opening/closing operation of the observer's eyelid, exerts control to turn off the image display section when the observer's eyelid has been kept closed to an extent equal to or more than a predetermined certain value. Thus, the image display device is kept from wastefully consuming electric power while the eyelid is closed by blinks in the waking state.

In an embodiment,

the sensor includes a left-eye sensor for detecting opening/closing operation of the left-eye eyelid of the observer and a right-eye sensor for detecting opening/closing operation of the right-eye eyelid of the observer, and

based on signals from the left-eye and right-eye sensors, the control unit exerts control to turn off the image display section when the eyelids of both left and right eyes of the observer have been closed to an extent equal to or more than a predetermined certain value.

According to this embodiment, based on signals from the left-eye and right-eye sensors, the control unit exerts control to turn off the image display section when the eyelids of both left and right eyes of the observer have been closed to an extent equal to or more than the predetermined certain value.

As shown above, in this embodiment, when the eyelids of both left and right eyes of the observer have concurrently been closed to an extent equal to or more than the predetermined certain value, the image display section is turned off. Therefore, even observers who show eyelid motions different between right and left eyes such as those having a tic disease are relieved from the burden of viewing the turned-off image display section, thus being prevented from recognition of flickering.

In an embodiment,

the sensors are Far-Infrared Radiation sensors capable of detecting temperature differences between an eyelid and an eye.

According to this embodiment, since the Far-Infrared Radiation sensors capable of detecting temperature differences between an eyelid and an eye are used as the sensors, such a light-emitting part (e.g., light-emitting diode) as described in PTL1 is unnecessary, requiring no light-emitting energy, so that further electric power saving can be achieved.

In an embodiment,

the control unit comprises:

threshold setting means for setting a threshold to be used for discrimination of closure of the eyelid;

comparison means for comparing a signal from the sensor with the threshold, wherein

based on a signal from the comparison means, the control unit exerts control to turn off the image display section.

The field of view of the observer differs among individuals. Accordingly, if the image display section is turned off with the eyelid not fully blocking the field of view, the observer is made to feel uncomfortable flickering. Meanwhile, if the image display section is not turned off with the eyelid fully blocking the field of view, then the image display section wastefully consumes energy. Thus, it is preferable that the threshold for discrimination of closure of the eyelid is set according to the observer having a field of view that differs among individuals.

In this embodiment, since the threshold setting means for setting a threshold for discrimination of closure of the eyelid is included, it becomes possible to set a threshold corresponding to the field of view of the observer, so that further electric power saving can be achieved and moreover occurrence of flickering can be prevented.

In an embodiment,

the control unit comprises:

threshold calculation means for calculating a threshold to be used for discrimination of closure of the eyelid based on a signal from the sensor, wherein

the comparison means compares a signal from the sensor with the threshold and, based on a signal from the comparison means, the control unit exerts control to turn off the image display section.

According to this embodiment, based on a signal from the sensor, a threshold corresponding to the field of view of each observer can be calculated by the threshold calculation means for calculating a threshold to be used for discrimination of closure of the eyelid. Therefore, by calculation of a threshold corresponding to the field of view of each observer, further electric power saving can be achieved and moreover occurrence of flickering can be prevented.

### Advantageous Effects of Invention

According to this invention, the image display device is kept from wastefully consuming electric power while the eyelid is closed by blinks in the waking state, because the control unit, upon receiving a signal from the sensor that detects opening/closing operation of the observer's eyelid, exerts control to turn off the image display section when the observer's eyelid has been kept closed to an extent equal to or more than a predetermined certain value.

### BRIEF DESCRIPTION OF DRAWINGS

FIG. 1 is a view showing an image display device according to a first embodiment of the invention, as well as an eyelid opened state thereof;

FIG. 2 is a view showing the image display device of the first embodiment, as well as an eyelid closed state thereof;

FIG. 3 is a graph showing an output waveform of a FIR (Far-Infrared Radiation) sensor resulting from one-time closing of the eyelid;

FIG. 4 is a block diagram of a control unit according to the first embodiment;

FIG. 5 is a schematic view showing a state that an eye is exposed with the eyelid opened;

FIG. 6 is a schematic view showing a state that the eyelid is closed until the field of view is blocked;

FIG. 7 is a flowchart of a threshold calculation means;

FIG. 8 is a graph showing an output waveform of the FIR sensor resulting from repeated opening and closing actions of the eyelid;

FIG. 9 is a view for explaining actions involved in the threshold calculation;

FIG. 10 is a view showing the relationship between a FIR sensor and the eyes according to a second embodiment;

FIG. 11 is a block diagram of a control unit of the second embodiment;

FIG. 12 is a graph showing, with exaggeration, a state in which left-and-right eyes blink at different timings;

### DESCRIPTION OF EMBODIMENTS

Hereinbelow, the present invention will be described in detail by way of embodiments thereof illustrated in the accompanying drawings.

### First Embodiment

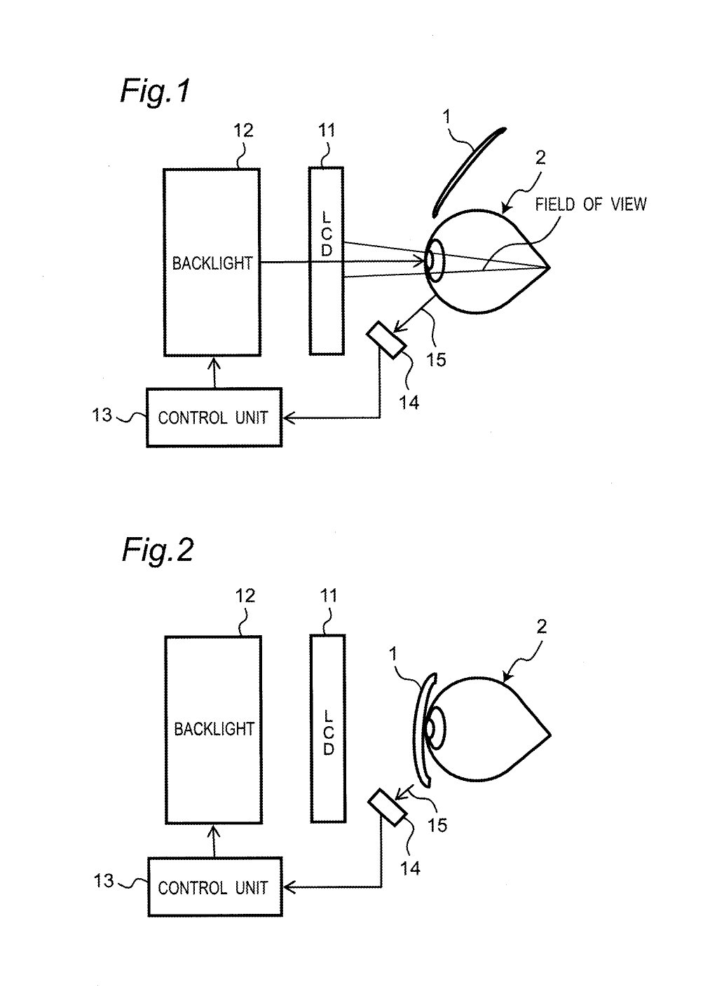

FIG. 1 shows an image display device of this first embodiment, as well as an eye state that an eyelid 1 is opened. FIG. 2 shows the image display device of the first embodiment, as well as an eye state that the eyelid 1 is closed.

As shown in FIGS. 1 and 2, the image display device of the first embodiment is, for example, a right-eye use head mounted display device or spectacle type display device, which includes an LCD (Liquid Crystal Display) 11 as an example of an image display section, a backlight 12 of the LCD 11, and a control unit 13 for performing turn-off control of the backlight 12. The LCD 11, as shown in FIG. 1, is positioned forward in the line of vision of the eye 2, where the line of vision of the eye 2 is horizontal.

The image display device also includes a FIR (Far-Infrared Radiation) sensor 14 as an example of a sensor for detecting opening and closing of the eyelid 1. The FIR sensor 14 is positioned diagonally downward of the eye 2 so as to be out of its field of view.

The reason that the FIR sensor 14 is enabled to detect the opening/closing of the eyelid 1 upon reception of far-infrared radiation 15 derived from the eyelid 1 or the eye 2 is as shown below.

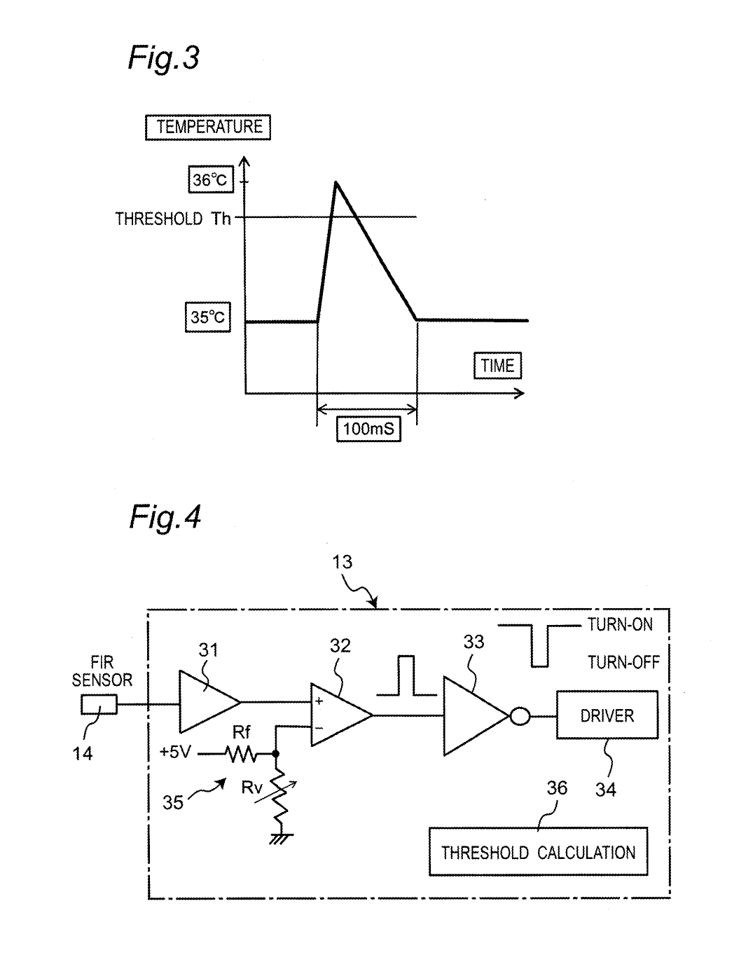

FIG. 3 shows an output of the FIR sensor 14, where the horizontal axis represents time and the vertical axis represents temperature and where an output variation during one blink is shown. The eye 2, because of its absorption of far-infrared radiation coming from the cornea into moisture on the cornea as well as heat radiation due to vaporization of the moisture, has a temperature of, for example, 35° C., which is lower than a temperature of the eyelid 1, 36° C. Therefore, the FIR sensor 14 detects the temperature 35° C. of the eye 2 with the far-infrared radiation 15 under a fully opened state of the eyelid 1 (hereinafter, the detected temperature will be referred to as open-state temperature 35° C.) and detects the temperature 36° C. of the eyelid 1 higher than the open-state temperature 35° C. of the eye 2 with the far-infrared radiation 15 derived from the eyelid 1 under a fully closed state of the eyelid 1 (hereinafter, the detected temperature will be referred to as closed-state temperature 36° C.), so that the FIR sensor 14 is enabled to securely detect the opening/closing of the eyelid 1. This FIR sensor 14, differing from PTL1, needs neither a light-emitting device for illuminating the eye with light nor light-emitting energy for driving the light-emitting device, thus having an advantage of less energy consumption.

In FIG. 3, reference character ‘Th’ denotes a later-described threshold value.

An output of the FIR sensor 14 is inputted to the control unit 13. When the output has exceeded a level corresponding to the threshold Th, the control unit 13 turns off the backlight 12 of the LCD 11.

As shown in FIG. 4, the control unit 13 includes an amplifier 31 for receiving the output of the FIR sensor 14, a comparator 32 as an example of comparison means, a fixed resistor Rf, a variable resistor Rv, an inverter 33, a driver 34, and a threshold calculation means 36 made from a microcomputer. The amplifier 31 amplifies a signal received from the FIR sensor 14. The fixed resistor Rf and the variable resistor Rv make up a threshold setting means 35, as an example, which divides a voltage of +5 V to set the threshold Th and then inputs the threshold Th to a negative (−) terminal of the comparator 32. The comparator 32 compares an output of the amplifier 31 inputted to a positive (+) terminal with the threshold Th, which is a voltage of a connecting point between the fixed resistor Rf and the variable resistor Rv. When the output of the amplifier 31 has exceeded the threshold Th, i.e., when a signal from the FIR sensor 14 has exceeded a level corresponding to the threshold Th, the comparator 32 outputs a high-level signal so as to output, via the inverter 33, a low-level signal to the driver 34, so that the backlight 12 of the LCD 11 is turned off.

The threshold Th set by the variable resistor Rv of the threshold setting means 35 is calculated by the threshold calculation means 36. The threshold calculation means 36 is made up by software of a microcomputer.

In the meantime, the temperature detected by the FIR sensor 14 in the opening/closing state of the eyelid 1 varies depending on room temperature, time and physical condition even for one identical observer. Thus, calculation and setting of the threshold Th is important.

Makeup and operation of the threshold calculation means 36 will be described below with reference to FIG. 3 and FIGS. 5 to 9.

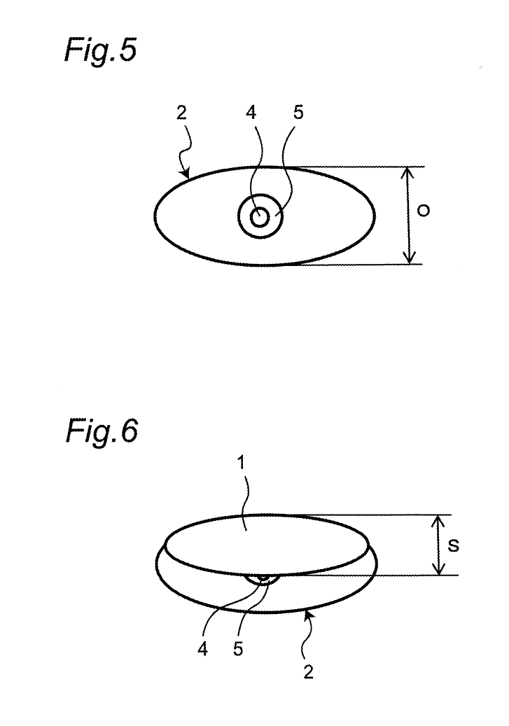

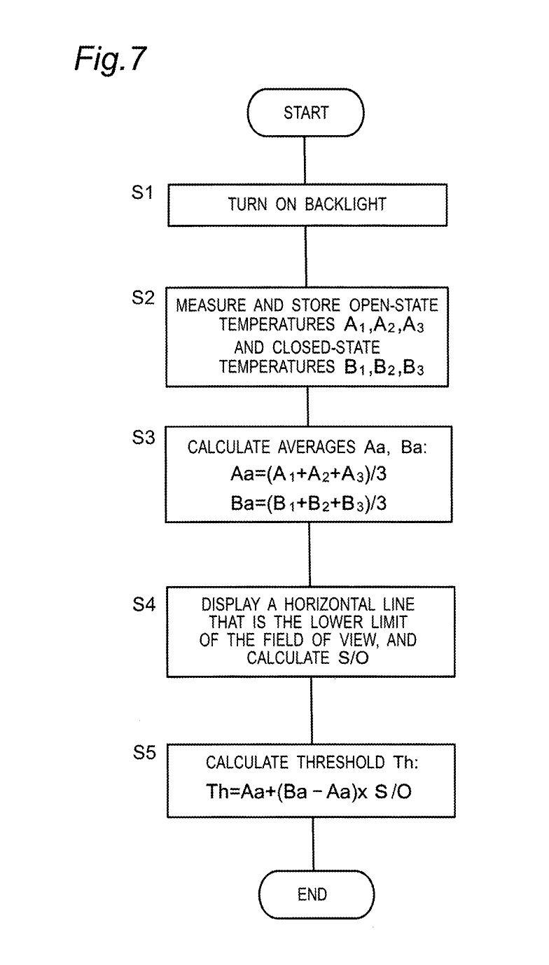

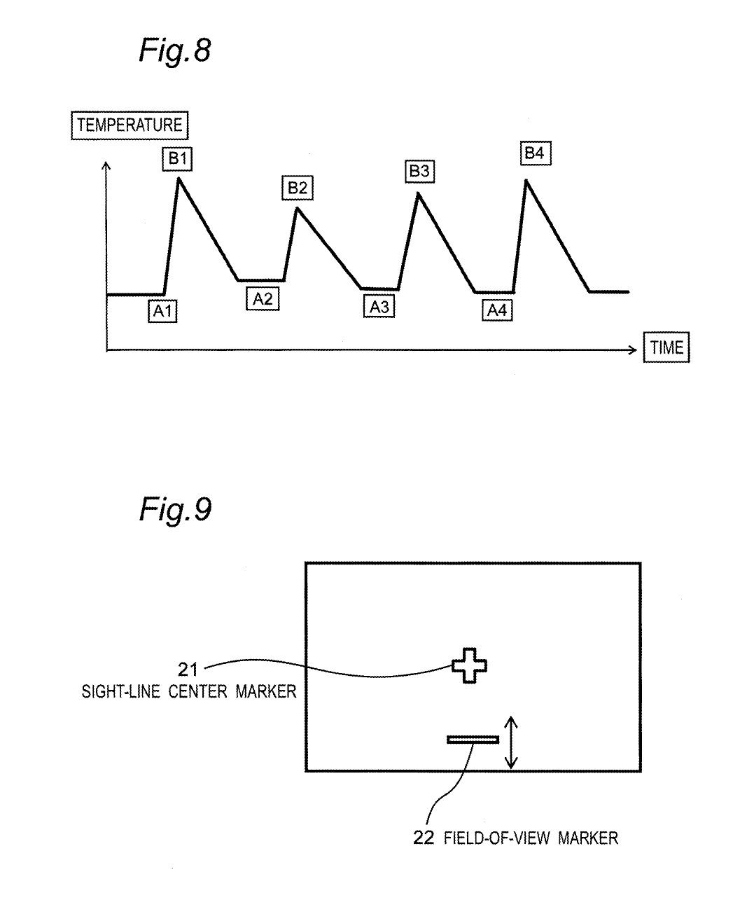

FIG. 5 is a view showing the eye 2 that is exposed to a maximum in a fully opened state. FIG. 6 is a view showing a state that the eyelid 1 has fallen so as to block the field of view. In FIGS. 5 and 6, reference sign 4 denotes a pupil and 5 denotes an iris. FIG. 7 is a flowchart showing operations of the threshold calculation means 36, FIG. 8 shows an output waveform of the FIR sensor 14, and FIG. 9 shows a screen of the LCD 11 in which a sight-line center marker 21 and a field-of-view marker 22 are displayed.

First, at step S1 shown in FIG. 7, the backlight 12 is lit. The backlight 12 is kept lit until a later-described threshold Th is calculated and stored.

Next, at step S2, open-state temperatures A₁, A₂, A₃ of the eye 2 and closed-state temperatures B₁, B₂, B₃ of the eyelid 1 shown in FIG. 8 are measured by the FIR sensor 14. Then, data representing these open-state temperatures A₁, A₂, A₃ and closed-state temperatures B₁, B₂, B₃ are stored into the memory of the threshold calculation means (microcomputer) 36. In order to obtain the data, although not shown, outputs of the FIR sensor 14 are amplified and subjected to A/D conversion (analog-to-digital conversion) to determine extreme values.

Next, at step S3, a three-point average Aa=(A1+A2+A3)/3 of the open-state temperatures A₁, A₂, A₃ as well as a three-point average Ba=(B1+B2+B3)/3 of the closed-state temperatures B₁, B₂, B₃ are calculated so as to reduce influences of variations in measured values.

As shown in FIG. 5, a detected temperature of the FIR sensor 14 in the fully opened state of the eye 2 with the eyelid 1 kept from falling generally corresponds to the open-state temperatures A₁, A₂, A₃ of FIG. 8. Also, although not shown, the state that the eyelid 1 has fully blocked the eye 2 in FIG. 5 corresponds to the closed-state temperatures B₁, B₂, B₃ of FIG. 8. Therefore, a difference (Ba−Aa) between the average Ba of the closed-state temperatures B₁, B₂, B₃ and the average Aa of the open-state temperatures A₁, A₂, A₃ can be made correspondent to a length O in FIG. 5. Meanwhile, as shown in FIG. 6, assuming that the field of view of the eye 2 is fully blocked by the eyelid 1 when the eyelid 1 has fallen by a length S, then the threshold Th to be determined results in

threshold Th=Aa+(Ba−Aa)×S/O.

The value of this S/O, which differs among individuals strictly, is determined at step S4 in the following manner. First, as shown in FIG. 9, the sight-line center marker 21 and the field-of-view marker 22 are displayed in the screen of the LCD 11. While the observer keeps watching the sight-line center marker 21, the field-of-view marker 22 is gradually moved downward, where when the field-of-view marker 22 has gone out of the field of view so that the observer can no longer discern the field-of-view marker 22, the then current position of the field-of-view marker 22 is correspondent to a lower limit of the field of view corresponding to the above-mentioned S. The observer, when becoming unable to discern the field-of-view marker 22, operates an unshown operating section, by which a position of the field-of-view marker 22 when the observer has become unable to discern the field-of-view marker 22 is specifically determined. Then, by looking up to a memory in which correspondence between positions of the field-of-view marker 22 (or distances between the sight-line center marker 21 and the field-of-view marker 22) and S have previously been stored, the threshold calculation means 36 reads an S to read a previously stored O and calculate an S/O. In addition, it is also allowable that correspondence between positions of the field-of-view marker 22 and S/O are previously stored and an S/O is read.

Next, at step S5, by using the above averages Aa, Ba and the value of S/O, a value of

threshold Th=Aa+(Ba−Aa)×S/O

is calculated and stored.

Now that the threshold calculation means 36 has calculated and stored the threshold Th as shown above, the threshold setting means 35, receiving a signal representing the threshold Th from the threshold calculation means 36, adjusts a resistance value of the variable resistor Rv and sets an input signal of the negative (−) terminal of the comparator 32 to the threshold Th.

In the image display device made up as described above, the FIR sensor 14 detects a temperature of the eye 2 or the eyelid 1 in response to the opening/closing of the eyelid 1.

Now it is assumed that the eyelid 1 has closed more than necessary to block all the field of view as shown in FIG. 2 or 6, i.e., that the eyelid 1 has fallen to an extent larger than S of FIG. 6. Then, the level of the signal from the FIR sensor 14 becomes higher than the level of the threshold Th shown in FIG. 3.

The signal from the FIR sensor 14 is inputted to the control unit 13 and, via the amplifier 31 shown in FIG. 4, inputted to the positive (+) terminal of the comparator 32. Meanwhile, the threshold Th is inputted to the negative (−) terminal of the comparator 32 by the threshold setting means 35. Since the signal inputted to the positive (+) terminal of the comparator 32 is higher in level than the threshold Th, a high-level signal is outputted from the comparator 32 and, via the inverter 33, a low-level signal is inputted to the driver 34. The driver 34 turns off the backlight 12.

Thus, under the waking condition, when the eyelid 1 has closed more than necessary to block all the field of view, the backlight 12 is turned off immediately. Accordingly, wasteful electric power consumption is eliminated so that the electric power saving can be achieved.

Meanwhile, while the eyelid 1 is opened or has not yet blocked all the field of view as shown in FIG. 1, the signal from the FIR sensor 14 becomes lower in level than the threshold Th shown in FIG. 3.

The signal from the FIR sensor 14 is inputted to the positive (+) terminal of the comparator 32 via the amplifier 31 shown in FIG. 4. Meanwhile, the threshold Th is inputted to the negative (−) terminal of the comparator 32 by the threshold setting means 35. Since the signal inputted to the positive (+) terminal of the comparator 32 is lower in level than the threshold Th, a low-level signal is outputted from the comparator 32 and, via the inverter 33, a high-level signal is inputted to the driver 34. The driver 34 turns on the backlight 12.

Thus, while the eyelid 1 is open even in part of the field of view, i.e., while the eyelid 1 has not blocked all the field of view, the backlight 12 is kept on, so that the observer watching the screen is kept from feeling a sense of discomfort due to flickering or the like.

What degree of electric power saving is achieved in this first embodiment will be discussed in detail below.

Assuming that the frequency and duration of eye blinks, although varying depending on sex, age and individuals, are a frequency of 20 times/min and a duration of 100 mS per blink (see FIG. 3) as an example, it follows that the eye 2 is closed for 2 sec per minute, allowing a ratio of 2 sec/60 sec to be derived, so that a maximum of 3.3% reduction of power consumption of the LCD 11 can be expected. Since the output of the FIR sensor 14 by opening/closing of the eyelid 1 is shaped into an inverted sawtooth waveform as shown in FIG. 3, how is the reduction quantity of power consumption as well as whether or not flickering of the screen is recognized depend on the level at which the threshold Th is set.

For example, assuming that the open-state temperature average Aa=36° C., the closed-state temperature average Ba=35° C. and S/O=⅔, then it follows that

threshold Th=Aa+(Ba−Aa)×S/O=35+(36−35)×⅔=35.7° C.

Reading time from the graph of FIG. 3 results in a light-off time of 40 mS for a one-time blink of 100 mS, showing that a 1% power saving is enabled. For example, in the case of a 12″-type LCD 11, the LED (Light-Emitting Diode) backlight requires a power consumption of 4 W, and the battery for tablet terminal devices of this liquid-crystal size runs on 7 V and 6600 mAh as an example. Thus, on condition that all the energy is used for the LED backlight, it can be calculated that the driving time elongates to an extent of 6 minutes, which is 1% of the light-on time of 11.5 hours.

### Second Embodiment

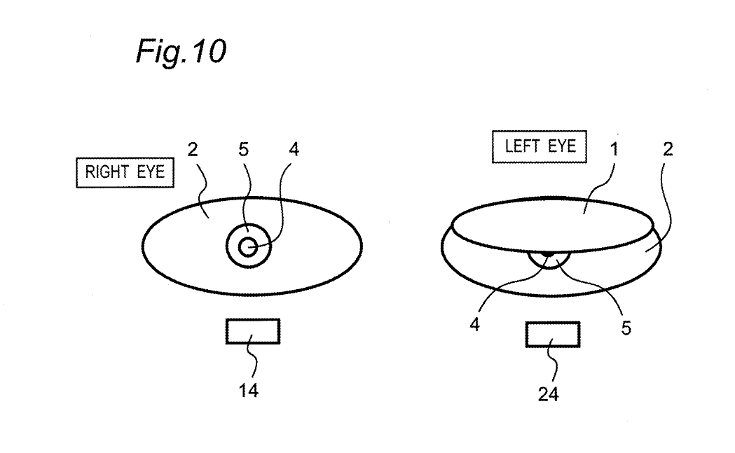

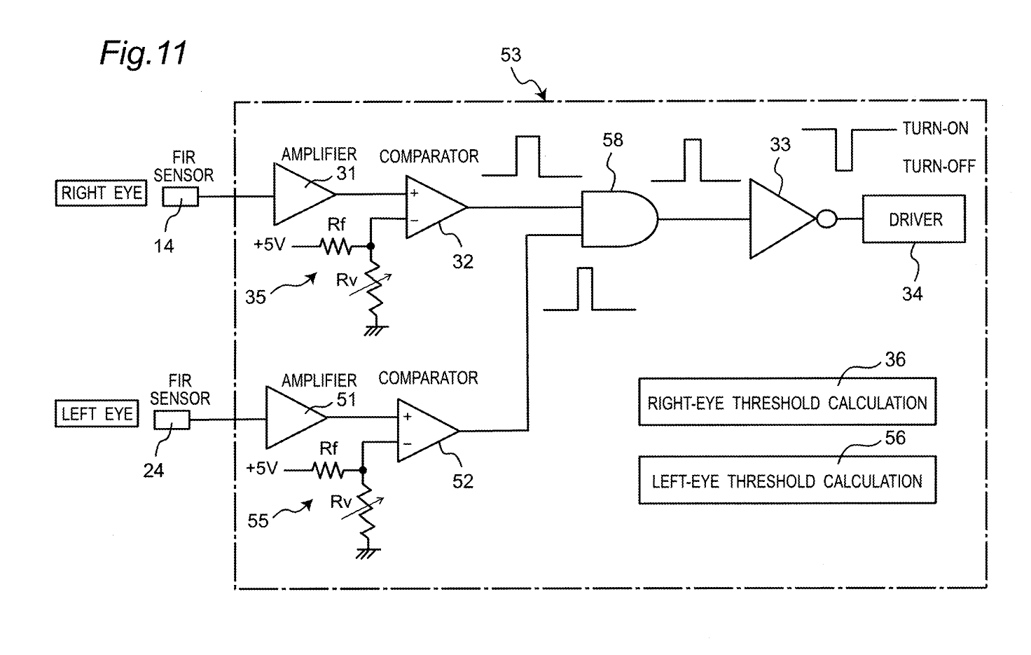

FIGS. 10 to 12 are views for explaining an image display device according to a second embodiment. The image display device of this second embodiment, unlike the image display device of the first embodiment designed for image viewing with the right eye, is an image display device for image viewing with both right and left eyes. In this second embodiment, although the LCD and the backlight are not shown in FIGS. 10 and 11, the LCD 11 and the backlight 12 of the first embodiment shown in FIGS. 1 and 2 are used also for this second embodiment. Besides, in the second embodiment, the same component members as in the first embodiment are designated by the same reference signs as in the first embodiment and their detailed description is omitted.

The image display device of the second embodiment has a right-eye FIR sensor 14 and a left-eye FIR sensor 24 as shown in FIG. 10. Signals from the right-eye FIR sensor 14 and the left-eye FIR sensor 24 are inputted to a control unit 53 shown in FIG. 11.

The control unit 53 includes amplifiers 31, 51, comparators 32, 52 as an example of comparison means, a fixed resistor Rf, a variable resistor Rv, an inverter 33, a driver 34, a right-eye threshold calculation means 36, a left-eye threshold calculation means 56, and an AND circuit 58.

The amplifier 31, the comparator 32, the inverter 33, the driver 34, the right-eye threshold setting means 35 and the right-eye threshold calculation means 36 are identical in construction to the amplifier 31, the comparator 32, the fixed resistor Rf, the variable resistor Rv, the inverter 33, the driver 34, the threshold setting means 35 and the threshold calculation means 36 of the first embodiment, and therefore designated by the same reference signs as their ones with their detailed description omitted.

Also, the left-eye threshold calculation means 56 differs from the right-eye threshold calculation means 36 only in calculating the threshold based on signals from the left-eye FIR sensor 24. Therefore, description of its construction and operation is omitted, and FIG. 7 is used for reference also in this case. Moreover, construction and function of the left-eye threshold setting means 55 are similar to those of the right-eye threshold setting means 35.

The amplifier 51 receives and amplifies a signal from the left-eye FIR sensor 24, and inputs the amplified signal to the positive (+) terminal of the comparator 52. To the negative (−) terminal of the comparator 52, a threshold Th set by the threshold setting means 55 made up of the fixed resistor Rf and the variable resistor Rv is inputted.

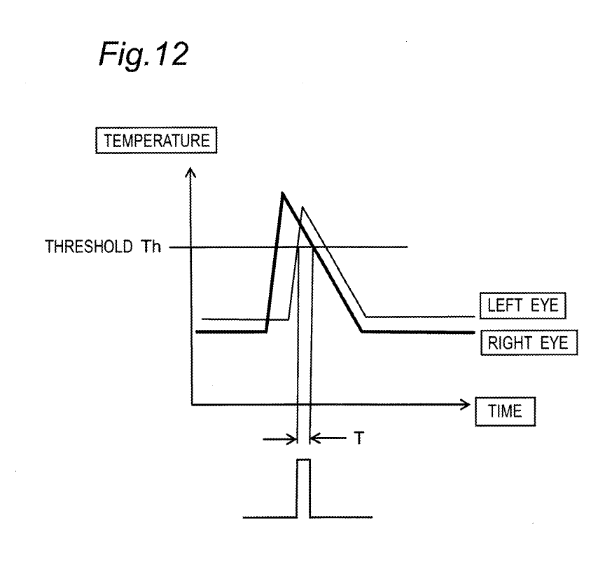

Outputs of the comparators 32, 52 are inputted to the AND circuit 58, where an AND operation is performed. Therefore, when signals exceeding the level of the threshold Th are inputted from both the right-eye FIR sensor 14 and the left-eye FIR sensor 24 via the amplifiers 31, 51 to the positive (+) terminals of the comparators 32, 52, a high-level signal keeps outputted from the AND circuit 58 during a period T shown in FIG. 12. Then, the high-level signal is turned to low level by the inverter 33 and inputted to the driver 34. Thus, the backlight 12 is turned off.

Although the threshold for the left-eye and the threshold for the right eye are assumed to be equal to each other in FIG. 12 for explanation's sake, yet those thresholds may be different from each other, of course.

As described above, in the second embodiment, AND operation is performed by the AND circuit 58 so that the backlight 12 is kept turned-off during the period T in which the right-eye eyelid 1 and the left-eye eyelid 1 are concurrently closed to an extent over the threshold Th as shown in FIG. 12. Thus, it never occurs that only one eye is blocked from entry of the image. As a consequence, even tic patients who show peculiar eyelid motions are prevented from recognition of flickering.

Although the threshold calculation means 36, 56 are provided in the first and second embodiments, it is also allowable that the threshold calculation means 36, 56 are not provided. For example, by the threshold setting means, a threshold value applicable to most observers may be set fixedly according to regions, races or the like, or with a plurality of threshold values prepared, a threshold value at which the observer feels no flickering may be set as appropriate.

Also, the threshold setting means may be designed so that selection from among a plurality of parallel-connected resistors is made with a switch to set a threshold.

Also, although FIR sensors are used as the sensor for detecting opening/closing of the eyelid in the first and second embodiments, yet this is not limitative, of course. Alternatively usable as the sensor for detecting opening/closing of the eyelid are, for example, sensors using a light-emitting device and an image pickup device (see JP 9-105853 A), and sensors for detecting electric potential of the retina to detect opening/closing of the eyelid (see JP 2011-87609 A).

Further, although an LCD is used as the image display section in the first and second embodiments, yet self-emitting displays (e.g., plasma displays, organic EL (Electro Luminescence), SEDs (Surface Condition Electron Emitter Displays), etc.) may also be used.

With regard to the image display device, its main casing (frame body), bands, cables, loudspeakers and the like have been well known in various types from PTL1 or the like. However, those equipment have no relation with the gist of the present invention and so their description is omitted in the first and second embodiments.

### REFERENCE SIGNS LIST

1 eyelid
2 eye
11 LCD
12 backlight
13, 53 control unit
14, 24 FIR sensor
32, 52 comparator
34 driver
35, 55 threshold setting means
36, 56 threshold calculation means
58 AND circuit

1. An image display device comprising:
an image display section;
a sensor for detecting opening/closing operation of an eyelid of an observer who observes the image display section; and
a control unit for, upon receiving a signal from the sensor, exerting control to turn off the image display section on condition that the observer's eyelid is kept closed to an extent equal to or more than a predetermined certain value.

2. The image display device as claimed in claim 1, wherein
the sensor includes a left-eye sensor for detecting opening/closing operation of the left-eye eyelid of the observer and a right-eye sensor for detecting opening/closing operation of the right-eye eyelid of the observer, and
based on signals from the left-eye and right-eye sensors, the control unit exerts control to turn off the image display section when the eyelids of both left and right eyes of the observer have been closed to an extent equal to or more than a predetermined certain value.

3. The image display device as claimed in claim 1, wherein
the sensors are Far-Infrared Radiation sensors capable of detecting temperature differences between an eyelid and an eye.

4. The image display device as claimed in claim 1, wherein
the control unit comprises:
threshold setting means for setting a threshold to be used for discrimination of closure of the eyelid;
comparison means for comparing a signal from the sensor with the threshold, wherein
based on a signal from the comparison means, the control unit exerts control to turn off the image display section.

5. The image display device as claimed in claim 4, wherein
the control unit comprises:
threshold calculation means for calculating a threshold to be used for discrimination of closure of the eyelid based on a signal from the sensor, wherein
the comparison means compares a signal from the sensor with the threshold and, based on a signal from the comparison means, the control unit exerts control to turn off the image display section.

6. The image display device as claimed in claim 2, wherein
the sensors are Far-Infrared Radiation sensors-capable of detecting temperature differences between an eyelid and an eye.

7. The image display device as claimed in claim 2, wherein
the control unit comprises:
threshold setting means for setting a threshold to be used for discrimination of closure of the eyelid;
comparison means for comparing a signal from the sensor with the threshold, wherein based on a signal from the comparison means, the control unit exerts control to turn off the image display section.

8. The image display device as claimed in claim 3, wherein
the control unit comprises:
threshold setting means for setting a threshold to be used for discrimination of closure of the eyelid;
comparison means for comparing a signal from the sensor with the threshold, wherein
based on a signal from the comparison means, the control unit exerts control to turn off the image display section.

9. The image display device as claimed in claim 6, wherein
the control unit comprises:
threshold setting means for setting a threshold to be used for discrimination of closure of the eyelid;
comparison means for comparing a signal from the sensor with the threshold, wherein
based on a signal from the comparison means, the control unit exerts control to turn off the image display section.

10. The image display device as claimed in claim 7, wherein
the control unit comprises:
threshold calculation means for calculating a threshold to be used for discrimination of closure of the eyelid based on a signal from the sensor, wherein
the comparison means compares a signal from the sensor with the threshold and, based on a signal from the comparison means, the control unit exerts control to turn off the image display section.

11. The image display device as claimed in claim 8, wherein
the control unit comprises:
threshold calculation means for calculating a threshold to be used for discrimination of closure of the eyelid based on a signal from the sensor, wherein
the comparison means compares a signal from the sensor with the threshold and, based on a signal from the comparison means, the control unit exerts control to turn off the image display section.

12. The image display device as claimed in claim 9, wherein
the control unit comprises:
threshold calculation means for calculating a threshold to be used for discrimination of closure of the eyelid based on a signal from the sensor, wherein
the comparison means compares a signal from the sensor with the threshold and, based on a signal from the comparison means, the control unit exerts control to turn off the image display section.
